(19) United States
(12) Patent Application Publication
(10) Pub. No.: US 2014/0212610 A1
(43) Pub. Date: Jul. 31, 2014

(54) FOAM-MOLDING PARTS MANUFACTURING METHOD, FOAM-MOLDING PART, AND FOAM-MOLD

(71) Applicants: Takashi Arai, Tokyo (JP); Keiichi Sato, Kawasaki-shi (JP); Tomoyasu Shirokawa, Kawasaki-shi (JP)

(72) Inventors: Takashi Arai, Tokyo (JP); Keiichi Sato, Kawasaki-shi (JP); Tomoyasu Shirokawa, Kawasaki-shi (JP)

(73) Assignee: CANON KABUSHIKI KAISHA, Tokyo (JP)

(21) Appl. No.: 14/342,040

(22) PCT Filed: Aug. 29, 2012
(86) PCT No.: PCT/JP2012/005438

§ 371 Date: Feb. 28, 2014

(30) Foreign Application Priority Data
Sep. 1, 2011 (JP) 2011-190374

(51) Int. Cl. B29C 44/58; B29C 45/40

(52) U.S. Cl. CPC B29C 44/586; B29C 45/401
USPC 428/36.5; 264/51; 425/577

(57) ABSTRACT

Two partings are provided, a movable core edge face where core back is performed with a mold plate being configured of multiple plates is provided within the thickness of a component edge face, and a driving unit is provided to a pushing-cut shape and a nipping shape.

With a molding process, after filling of a foaming resin, the sub parting moves in the core-back direction by predetermined amount, but a punching insert block, a nipping insert block, a slant core, and an outer slider do not move in the core-back direction, and maintain in a position before core back.

### TECHNICAL FIELD

The present invention relates to a foam-molding parts manufacturing method, foam-molding parts, and a foam-mold, which are for obtaining molding parts by injecting a foaming resin material into a foaming mold.

### BACKGROUND ART

Heretofore, a foaming agent such as butane gas, methane gas, water, nitrogen, carbon dioxide gas, or the like is infiltrated into a resin, or melt kneading or chemical reaction is mechanically induced, thereby manufacturing a foaming resin. Thereafter, the manufactured foaming resin is subjected to injection or extrusion molding within a mold using an injection molding machine, extrusion molding machine, or the like, thereby processing foam-molding parts having a desired shape and foaming ratio. However, in the event of increasing a forming diameter to increase a foaming ratio such as with Styrofoam or the like used in packing material, this causes a problem in that partition walls between foaming cells are thinned, and the strength of the foaming parts is markedly lowered.

Also, in recent years, there has been used a method wherein nitrogen or carbon dioxide gas in a supercritical state under high-pressure high temperature is infiltrated into a resin material, the pressure and temperature are adjusted to obtain foam-molding parts in which a great number of forming diameters having a micron size are included (see PTL 1). In the event of employing this method, cell diameters have a micron size, and accordingly, lowering of molding parts strength is reduced. However, in general, it has been difficult to increase foaming ratio, and weight reduction owing to foaming remains in 10% or so, and accordingly, which causes a problem in that economic effects such as material cutback and so forth are small. Further, there yet remains a problem in that warpage called box warpage, due to inward falling of a wall starting at a corner portion that occurs with common molding parts due to a small foaming ratio.

Further, there has been used a molding method called core back wherein, with foam-molding, after a foaming resin is injected into a mold, the capacity of the mold is expanded to increase the foaming ratio.

With core back foam-molding, in addition to a method for subjecting the entirety to core back, there has also been used a method for partially performing core back (see PTL 2 and PTL 3). With the core back method, deterioration in strength is suppressed by the thickness of a cross section increasing to increase cross-sectional rigidity in accordance with increase in the foaming ratio.

### CITATION LIST

### Patent Literature

PTL 1: U.S. Pat. No. 4,473,665

### PTL 2: Japanese Patent Laid-Open No. 2003-170762

### PTL 3: Japanese Patent Laid-Open No. 2006-76124

### SUMMARY OF INVENTION

However, with the core back molding method, the capacity of a mold is expanded, and accordingly, the mold has to be moved entirely or partially. In the event that component shapes include a hole shape, an undercut shape, a nipping shape made up of a cavity and a core, a curvature of an edge face, and so forth, it has been difficult to create a desired shape due to, such as occurrence of burring, instability of shape precision, damage of mold and component shape, and so forth.

Also, though there has been devised a technique for preventing a mold from moving at the time of core back operation using an oil cylinder or the like by a portion of the shape of the mold having a nested configuration (see PTL 3), this causes a problem in that the mold configuration becomes complicated, and flexibility of mold design is reduced, and accordingly, it is difficult to apply this technique to many components.

A foam-molding parts manufacturing method according to the present invention is a foam-molding parts manufacturing method, wherein a the fixed-side mold plate and a movable-side mold plate are closed, thereby forming a cavity within a mold, and a foaming resin is injected into the cavity, and then, the capacity of the cavity is expanded to promote foaming within the cavity, and after cooling, the fixed-side mold plate and the movable-side mold plate are opened to extract molding parts from the cavity;

with expansion of the capacity of the cavity being performed by moving a movable core forming a portion of the cavity relative to the cavity while closing the fixed-side mold plate and the movable-side mold plate.

Also, the foam-molding part according to the present invention is a box-shaped foam-molding part made up of a top face portion and a side face portion, wherein a weight reduction ratio of the side face portions is smaller as to a weight reduction ratio of the top face portion.

Also, a foam-mold according to the present invention is a foam-mold configured to inject a foaming resin into a cavity to form foam-molding parts, including a main parting made up of a fixed-side mold plate and a movable-side mold plate, a sub parting made up of a movable-side mold plate and a second movable-side mold plate or a sub parting made up of the fixed-side mold plate and the second fixed-side mold plate, and a movable core forming a portion of the cavity, wherein the movable core moves relative to the cavity in the direction of expanding the cavity while opening the sub parting.

With the present invention, there are provided two partings of a main parting and a sub parting, and a movable-side mold plate being configured of multiple plates, and accordingly, a particular driving source for core back operation does not have to be provided, and economic effects and flexibility of mold design are improved.

Further features of the present invention will become apparent from the following description of exemplary embodiments with reference to the attached drawings.

### BRIEF DESCRIPTION OF DRAWINGS

FIG. 1 is a diagram of a mold according to a first embodiment.

FIG. 2A is a cross-sectional view of a molding part according to the first embodiment.

FIG. 2B is a cross-sectional view of a molding part according to the first embodiment.

FIG. 3A is a cross-sectional view of a mold according to the first embodiment after a foaming resin is filled in a mold.

FIG. 3B is a cross-sectional view of a mold according to the first embodiment after a foaming resin is filled in a mold.

FIG. 3C is a cross-sectional view of a mold according to the first embodiment after a foaming resin is filled in a mold.

FIG. 4 is a cross-sectional view of a molding part according to the first embodiment.

FIG. 5 is an explanatory diagram of existing molding part damage.

FIG. 6 is a cross-sectional view of a mold portion according to the present invention.

FIG. 7 is a configuration diagram of a second mold according to the first embodiment.

FIG. 8A is a cross-sectional view of a second molding part according to the first embodiment.

FIG. 8B is a cross-sectional view of the second molding part according to the first embodiment.

FIG. 9A is a cross-sectional view of the second molding part according to the first embodiment.

FIG. 9B is a cross-sectional view of the second molding part according to the first embodiment.

FIG. 10A is an explanatory cross-sectional view of a slide portion according to the first embodiment.

FIG. 10B is an explanatory cross-sectional view of a slide portion according to the first embodiment.

FIG. 11A is a cross-sectional view of a driving unit mold.

FIG. 11B is a cross-sectional view of a driving unit mold.

FIG. 11C is a cross-sectional view of a driving unit mold.

FIG. 12A is a cross-sectional view of a driving unit mold within an attachment plate according to the first embodiment.

FIG. 12B is a cross-sectional view of a driving unit mold within an attachment plate according to the first embodiment.

FIG. 13A is an explanatory diagram of an existing technique.

FIG. 13B is an explanatory diagram of an existing technique.

FIG. 13C is an explanatory diagram of an existing technique.

FIG. 14 is a diagram of a mold according to a second embodiment.

FIG. 15A is a cross-sectional view of a mold according to the second embodiment after a foaming resin is filled in a mold.

FIG. 15B is a cross-sectional view of a mold according to the second embodiment after a foaming resin is filled in a mold.

FIG. 15C is a cross-sectional view of a mold according to the second embodiment after a foaming resin is filled in a mold.

### DESCRIPTION OF EMBODIMENTS

Embodiments of the present invention will be described with reference to the following drawings.

### First Embodiment

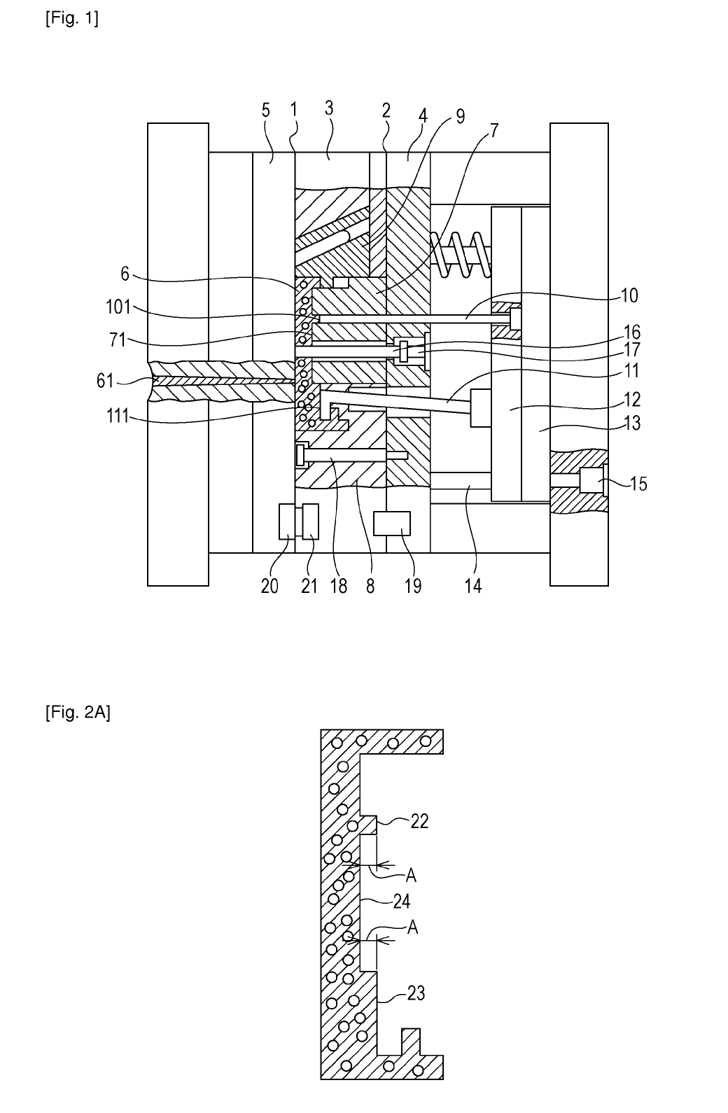

FIG. 1 illustrates a basic configuration of a foam-mold according to the first embodiment, and a portion thereof is illustrated with a cross section for easy to understand. The cross-sectional portion is indicated with hatching. With the present Specification, core back means movement of a core in a direction expanding the capacity of a cavity for molding of foam-molding part (mold opening direction).

In FIG. 1, reference numeral 1 is a main parting, and reference numeral 2 is a sub parting wherein a movable-side mold plates are divided into multiple plates, and are opened for predetermined amount at the time of core back operation (at the time of movement of a second movable-side mold plate). Reference numeral 3 is a movable-side mold plate making up the main parting using a contact face with a fixed-side mold plate, reference numeral 4 is a second movable-side mold plate which moves in conjunction with core back operation and is removable from the movable-side mold plate 3, and is movable in the mold opening direction, reference numeral 5 is a fixed-side mold plate, and reference numeral 6 is a foam-molding parts shape portion (cavity) formed within a mold. Reference numeral 61 denotes a resin injection hole for injecting a foaming resin into the cavity 6. As for a foaming resin to be injected into the cavity, a resin which has commonly been employed can be employed. For example, there can be employed a resin into which a foaming agent such as butane gas, methane gas, water, nitrogen, carbon dioxide gas, or the like is infiltrated, a resin to which melt kneading or chemical reaction is mechanically induced, or a resin into which nitrogen or carbon dioxide gas in a supercritical state under high-pressure high temperature is infiltrated, or the like.

Also, reference numeral 7 is a movable core which performs core back operation, a surface 71 thereof makes up a portion of the cavity. The movable core 7 is fixed to the second movable-side mold plate 4. Reference numeral 8 is a non-movable core (insert block) of which the position is not changed at the time of core back operation (at the time of movement of a second movable-side mold plate), reference numeral 9 is an outer slide which forms an undercut shape, connects to the movable-side mold plate 3, and operates in conjunction with opening/closing of the main parting, and reference numeral 10 denotes an ejector pin.

According to the present Specification, a moveable core means a core that moves relative as to a cavity, in the direction of expanding the capacity of a cavity for forming foam-molding parts, before opening the main parting which is the contact face between the fixed-side mold plate and the movable-side mold plate.

Reference numeral 11 denotes a slant core which processes undercut, reference numeral 12 denotes a first ejector plate which connects to the ejector pin and slant core, and reference numeral 13 denotes a second ejector plate which connects to the first ejector plate 12. Also, reference numeral 14 denotes a return pin which returns the ejector plates to a predetermined position at the time of mold clamping.

Reference numeral 15 denotes an ejector plate driving unit which is disposed within the movable-side attachment plate, adjacent to the second ejector plate 13 at the time of mold clamping and at the time of core back operation (at the time of movement of the second movable-side mold plate). Reference numeral 16 denotes a punching pin forming a hole shape for a component, and reference numeral 17 denotes a punching pin driving unit which presses the punching pin against the fixed-side mold plate.

Further, reference numeral 18 denotes a core back amount regulating bolt which connects the movable-side mold plate 3 and second movable-side mold plate 4 to regulate core back operation amount, and reference numeral 19 denotes a movable-side mold plate pressing driving unit which presses the movable-side mold plate 3 against the fixed-side mold plate 5 side at the time of core back operation (at the time of movement of the second movable-side mold plate). Reference numerals 20 and 21 are main parting fixing units which fix the main parting at the time of core back operation (at the time of movement of the second movable-side mold plate).

At the time of core back operation (at the time of movement of the second movable-side mold plate), the sub parting 2 which is a contact face between the movable-side mold plate 3 and the second movable-side mold plate 4 is opened, the movable core 7 moves in the mold opening direction along with the sub parting, which increases the cavity capacity for forming molding parts to promote foaming.

At this time, the main parting is prevented from opening by the movable-side mold plate pressing driving unit 19 pressing the movable-side mold plate 3 against the fixed-side mold plate 5, and also by operations of the main parting fixing units 20 and 21.

Also, the main parting is prevented from opening, and accordingly, the outer slide 9 is prevented from moving at the time of core back operation (at the time of movement of the second movable-side mold plate).

The ejector plate driving unit 15 presses the first and second ejector plates 12 and 13 in the fixed-side mold plate direction, and accordingly, since the ejector plates 12 and 13 do not move as to the return pin 14, the slant core 11 is also prevented from moving. Similarly, the ejector pin 10 connected to the ejector plates is also prevented from moving during core back operation.

As illustrated in FIG. 1, tip portions 111 and 101 of the slant core 11 and ejector pin 10 prevented from moving at the time of core back (at the time of movement of the second movable-side mold plate) respectively are disposed in a position where the surface 71 of the movable core is positioned beforehand in a position to be positioned after completion of core back operation. Also, the main parting fixing unit is a fixing unit which fixes a permanent magnet or elastic member component using high pressure, and the main parting is configured to be opened when certain force is applied to the main parting fixing unit.

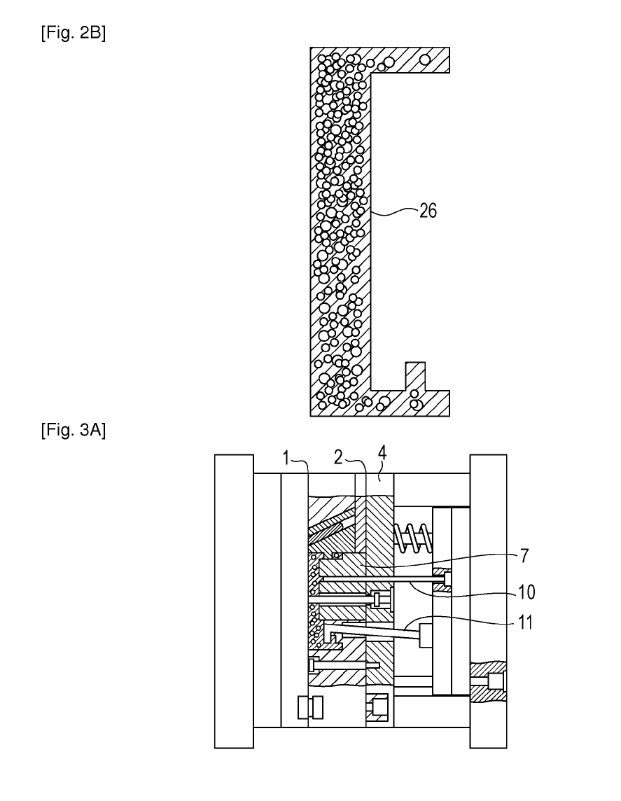

FIGS. 2A and 2B illustrate an example of a cross section of a molding part according to the present invention. FIG. 2A is a cross section of a component shape after a resin is filled in the cavity formed within a mold, reference numeral 22 denotes a portion adjacent to the tip portion of the ejector pin, reference numeral 23 denotes a portion adjacent to the tip portion of the slant core, reference numeral 24 denotes a portion adjacent to the surface of the movable core, and A indicates amount for core back.

In FIG. 2A, immediately after a foaming resin material is filled in the cavity within a mold, cells having generally the same size are in a state uniformly distributed within a molding part, and the number of cells and cell density thereof are still not so high. This is because filling pressure is applied in accordance with the viscosity of the resin at the time of filling a resin, filling pressure is further applied after reaching mold capacity, and accordingly, foaming due to reduced pressure is prevented from occurring.

With the present invention, in the event that an undercut shape is processed at the slant core, as described in FIG. 1, the ejector plates are prevented from moving at the time of core back operation (at the time of movement of the second movable-side mold plate). Therefore, the tip portion 111 of the slant core is positioned in a position serving as the same face as a position after core back of the movable core indicated with A beforehand. Thus, as illustrated in FIG. 2A, from the time of filling with resin, the portion 23 adjacent to the tip portion of the slant core is consequently positioned in a position serving as the same face as a position after core back of the movable core indicated with A. The portion 22 adjacent to the tip portion of the ejector pin is also positioned in the same way.

FIG. 2B illustrates the shape of a foam-molding part after core back, manufactured using a foam-molding parts manufacturing method according to the present invention.

The movable core moves by the amount indicated in FIG. 2A, and accordingly, the portion 23 adjacent to the tip portion of the ejector pin, the portion 22 adjacent to the tip portion of the slant core, and a portion adjacent to the surface of the movable core are lined up on the same surface illustrated in reference numeral 26.

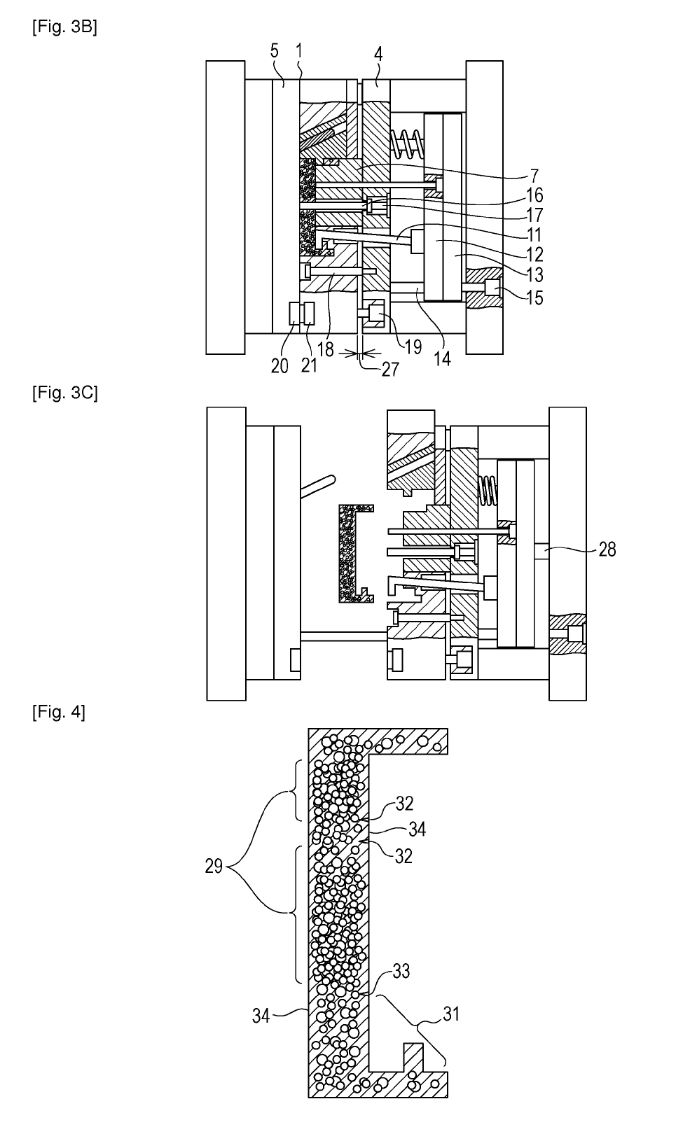

Next, the operation of a mold according to the present invention will be described with reference to FIG. 3.

FIG. 3A illustrates a state immediately after a foaming resin is filled in a mold, the main parting 1 and sub parting 2 are in a closed state. At this time, the ejector pin 10 and slant core 11 are fixed in a final thickness position.

After the foaming resin is filled, as illustrated in FIG. 3B, a mold attachment plate on the movable side (commonly referred to as movable-side platen) is moved by predetermined core back amount under the control on the molding machine side. According to this operation, the second movable-side mold plate 4 and the movable core 7 fixed in the second movable-side mold plate 4 are moved by the same amount. Reference numeral 27 denotes core back amount.

At the time of core back operation, the punching pin 16 making up a hole shape of a component is pressed against the cavity plate 5 by the punching pin driving unit, and accordingly, the punching pin 16 is prevented from moving from the position illustrated in FIG. 3A where the foaming resin is filled. Therefore, a gap is prevented from being generated between the punching pin and the fixed-side mold plate during core back operation, and accordingly, burring is prevented from occurring. Also, the punching pin 16 is positioned in the same position, whereby the precision of the hole can be maintained.

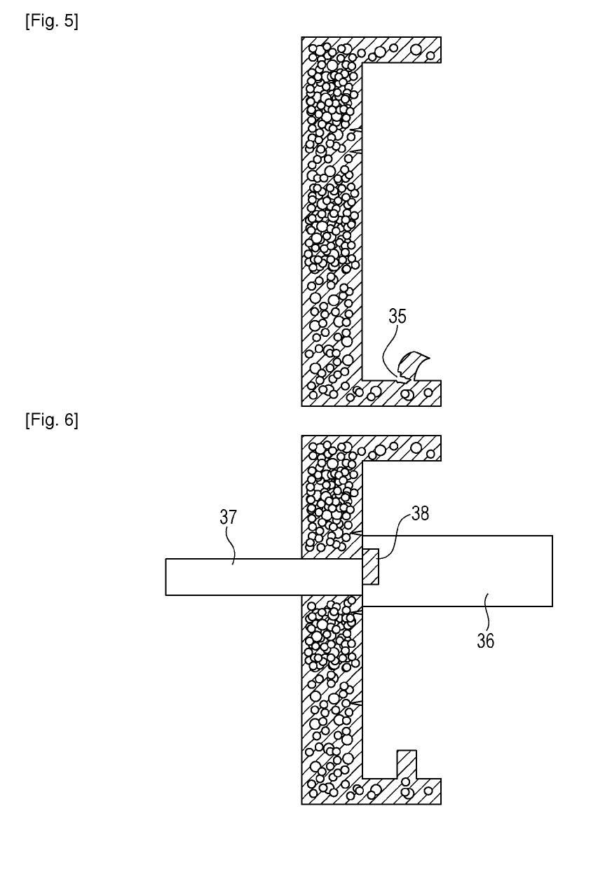

Similarly, with the slant core 11 forming an undercut at the time of core back, the ejector plate driving unit 15 presses the second ejector plate 13 in the direction of the return pin 14, and accordingly, the first ejector plate 12 is prevented from moving from the position illustrated in FIG. 3A. Therefore, the slant core prevents the undercut shape from moving in the ejector plate direction during core back operation. As a result thereof, the undercut shape illustrated in later-described FIG. 5 is prevented from being damaged. Also, the undercut shape is positioned in the same position, whereby the precision of the undercut shape portion can be maintained.

The movement amount for core back is regulated by a core back amount regulating bolt, in the event that the movable-side platen of the molding machine has moved equal to or greater than the stroke of the core back regulating bolt, the main parting 1 is opened, and foaming toward the cavity plate side occurs. In general, the movement amount for core back is controlled by the molding machine, which is set within the stroke of the core back amount regulating bolt.

In FIG. 3B, the core mold plate pressing driving unit 19 provided within the second core mold plate 4 presses the first core mold plate 3 against the main parting side so as not to open the main parting at the time of core back (at the time of movement of the second movable-side mold plate). Simultaneously, the main parting is fixed by the main parting fixing unit in which force such as the magnets 20 and 21 and so forth acts. According to action of these, in the event that the core back amount is within the stroke of the core back regulating bolt, the main parting is prevented from opening at the time of core back operation (at the time of movement of the second movable-side mold plate).

Accordingly, with the mold configuration according to the present invention, the main parting is not opened at the time of core back operation (at the time of movement of the second movable-side mold plate), and accordingly, occurrence of burring is prevented in the main parting area, and a foam-molding part having suitable shape precision can be obtained.

FIG. 3C illustrates operation at the time of taking out a component after cooling of the resin within the mold. According to the mold opening operation of the molding machine, the main parting is opened, a molding machine ejector rod 28 is advanced, the ejector plates are pushed out, and the molding part is taken out.

FIG. 4 illustrates features of a cross section of a molding part according to the present invention, wherein reference numeral 29 denotes a cross section where the movable core is subjected to core back, reference numerals 30 and 31 are the tip portion of the ejector pin, and the tip portion of the slant core, and illustrates a cross section of a portion where there is no thickness change according to core back. Also, a minute groove with width between 0.02 mm and 1.5 mm, and depth between 0.02 mm and 0.5 mm as illustrated in reference 32 is formed around a boundary between the ejector pin tip portion and the movable core. Similarly, a minute groove with width between 0.02 mm and 1.5 mm, and depth between 0.02 mm and 0.5 mm as illustrated in reference 33 is formed around a boundary between the slant core and the movable core.

As with the present invention, with a portion where a movable portion and a non-movable portion at the time of core back operation (at the time of movement of the second movable-side mold plate) are mixed, a minute groove is formed in a boundary thereof, but this groove is minute, and accordingly, influence to be given on the strength of a molding part and so forth is very small.

Also, the internal configuration of a molding part accomplished by employing the foam-mold and manufacturing method according to the present invention is, as a feature, configured of a portion where the foaming density of a movable core portion denoted by reference numeral 29 denotes high, and a portion where the foaming density of non-movable portions denoted by reference numerals 30 and 31 is low. Further, almost no thickness change occurs regarding a side portion (lateral wall) having thickness in the vertical direction as to the mold opening/closing direction of an edge face, or the like, and accordingly, the foaming density is lowered as a feature.

An undercut portion of molding parts accomplished by employing the foam-mold and manufacturing method according to the present invention has a feature wherein the foaming density is low, and accordingly, deterioration in strength is very small. Also, in the event of a box shape illustrated in FIG. 4, when force is applied to a top face denoted by reference numeral 34, the foaming ratio of a side portion (lateral wall) is low, and strength deterioration due to foaming is very small, and accordingly, there are a feature and effect in that the deformation volume of the entirety can be reduced. With the present invention, a portion having plate thickness in the mold opening direction will be referred to as top face portion, and a portion having plate thickness in the mold opening direction and vertical direction will be referred to as side face portion. Let us say that the vertical direction mentioned here includes even a direction inclined 5 degrees from the vertical direction.

FIG. 5 is a cross-sectional view of a molding part in the case of synchronously moving the slant core for molding the side portion at the time of core back operation without carrying out the mold and manufacturing method according to the present invention, wherein the undercut portion 35 is damaged by core back operation of the slant core. That is to say, it is difficult to manufacture the undercut shape of the side face portion using existing mold configuration and method without using the mold and manufacturing method according to the present invention, which prevents a desired shape from being manufactured.

FIG. 6 is an example wherein the mold configuration according to the present invention has been applied to a nipping shape portion. A nipping shape portion 38 is formed of a nipping pin 36 on the movable side and a diving pin 37 on the fixed side. The nipping pin is connected to a nipping pin driving unit which presses the nipping pin against the fixed-side mold plate direction in the same way as with the punching pin according to the present invention illustrated in FIG. 1. At the time of core back operation (at the time of movement of the second movable-side mold plate), the position thereof is not changed, and accordingly, burring does not occur between the nipping pin 36 on the movable side and the diving pin 37 on the fixed side. Accordingly, in the event of performing core back operation by applying the mold configuration and operation according to the present invention to the nipping shape, a component with suitable shape precision having no occurrence of burring can be obtained.

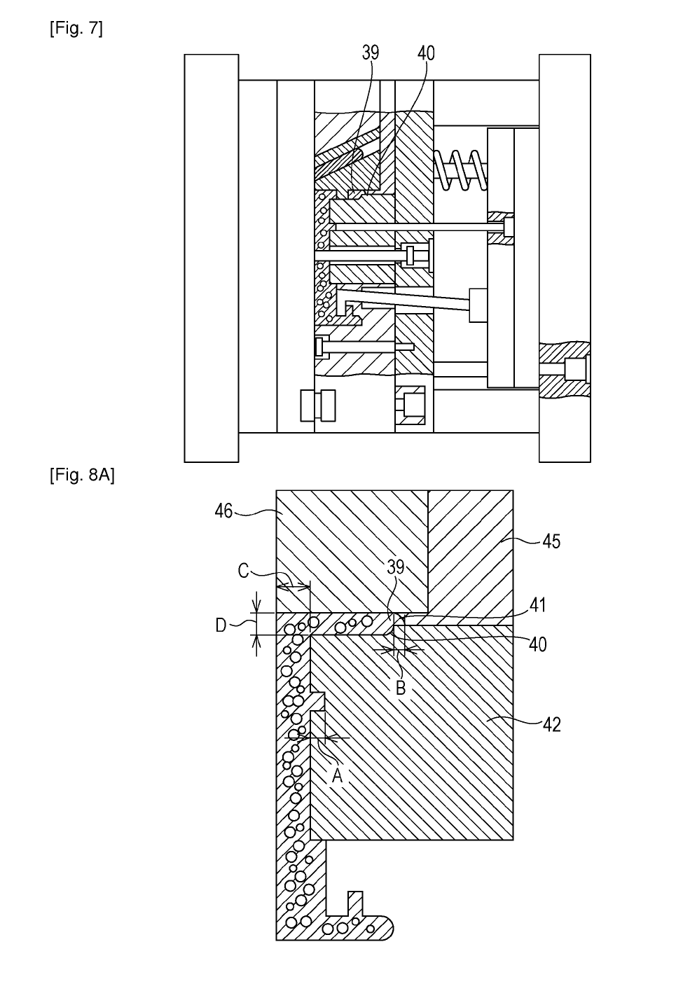

FIG. 7 illustrates a mold configuration wherein a full curvature (semicircular shape) is added to a component edge face of the side face portion in the present invention.

FIG. 8 is a diagram enlarged from the cross sections of the top face portion and side face portion in FIG. 7, and particular a diagram enlarged from the cross section of the edge face portion of the side face portion. A circular shape is formed on an edge face 40 of a movable core 42, and on an edge face 41 of a insert block 45, and after movement of the movable core, a curvature (semicircular shape) is formed with the circular shape formed on the movable core, and the circular shape formed on the insert block.

FIG. 8A illustrates a state before performing core back operation, where the edge face 40 of the movable core which performs core back operation is positioned within the thickness of the edge face 39 of the side face portion formed of the movable core 42, insert block 45, and insert block 46, and also positioned on the fixed-side mold plate side by the amount indicated by B.

FIG. 8B illustrates a state after core back movement, where the movable core moves by predetermined amount, thereby forming an edge face curvature (semicircular shape) as illustrated in reference numeral 44.

Specifically, as illustrated FIG. 7 and FIG. 8, after movement of the movable core, a curvature (semicircular shape) can be formed on the edge face of the side face portion by employing the mold configuration and method according to the present invention wherein the movable core is moved within the thickness of the edge face of the side face portion. Thus, damage at the time of a user who handles a product operating a component can be prevented.

Also, the movement amount of the movable core (core back movement amount) indicated with A, and the movement amount of the movable core of the edge face of the side face portion (core back movement amount) indicated with B have relationship indicated with the following expression.

[Math.1]

C≧1.0 mm, A≧B, D≧2.0 mm (Expression 1)

The movable core can be moved in a smoother manner by adding a combining slope (slant) to the movable core and insert block 45 (details will be described later). In the event of having this combining slope, the movement amount of the movable core (core back movement amount) indicated with A becomes greater than the movement amount of the movable core (core back movement amount) of the edge face of the side face portion indicated with B. In the even of adding no combining slope, the movement amount of the movable core (core back movement amount) indicated with A becomes equal to the movement amount of the movable core (core back movement amount) of the edge face of the side face portion indicated with B.

Also, C indicates the thickness in the core back direction (top face portion) before core back, and D indicates the thickness of the side face portion.

In the event that the thickness D of the edge face portion of the side face portion is thinner than 2.0 mm, cooling solidification advances in a portion subjected to molding at the insert blocks 45 and 46 where core back of the edge face portion 39 of the side face portion is not performed. Therefore, at the time of the movable core moving in the core back direction, a portion that moves in the core back direction, and a portion that does not move occur within the thickness of the edge face portion of the side face portion formed of the insert blocks 45 and 46, shearing stress acts on a boundary around the center of the thickness, and internal stress occurs. This internal stress becomes a cause of deformation after cooling. Further, there may be a case where cooling solidification on an outer-side portion where core back movement is not performed advances, and internal resin viscosity increases, and accordingly, even if core back operation is performed, the resin surface does not follow core back, and predetermined shape precision is not obtained.

With the present invention, as a result of having advanced research, internal stress that causes deformation as to the edge face portion of the side face portion after core back operation can be reduced, and deformation of molding part can be eliminated by setting the thickness D of the side face portion to 2.0 mm or more. Also, a full curvature (semicircular shape) on the edge face portion of the side face portion after core back can be processed with suitable precision.

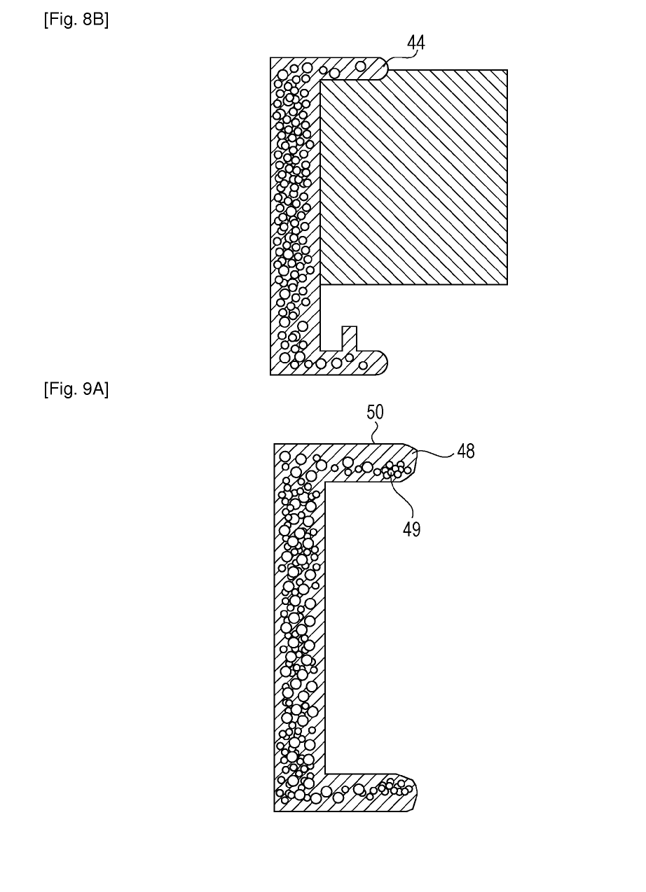

FIG. 9A is a cross section of a molding part which represents a feature of the molding part according to the present invention.

In FIG. 9A, reference numeral 49 denotes a portion formed with core back operation by the movable core, and reference numeral 50 denotes a non-movable portion at the time of core back operation (at the time of movement of the second movable-side mold plate).

As illustrated in FIG. 9A, the weight reduction ratio of the side face portion can be set to 50% or less as to the weight reduction ratio of the top face portion. Thus, a percentage for the strength of the side face portion falling due to foaming can extremely be reduced, which is very effective for a component having a box component shape which receives force on the top face portion, or the like. The weight reduction ratio mentioned here indicates a weight percentage of molding parts (foam-molding parts) including cells as to the weight of molding parts without cells (molding parts without foaming). In the event that the weight reduction ratio of the side face portion is 50% or less as to the weight reduction ratio of the top face portion, this means that, for example, when assuming that the weight reduction ratio of the top face portion (the weight ratio of the top face portion molded with foaming as to the weight of the top face portion molded without foaming) is 20%, on the other hand, the weight reduction ratio of the side face portion (the weight ratio of the side face portion molded with foaming as to the weight of the side face portion molded without foaming) is 10% or less.

Also, with the side face portion as well, while a great number of fine cells are formed on an inner face portion 49, the number of cells formed on the portion of an outer side face portion 50 is small. With the present invention, a boundary portion of the movable core which performs core back movement is provided within the thickness of the edge face portion of the side face portion, and accordingly, a configuration having a different cell formation can be manufactured within the cross section illustrated in FIG. 9A. In particular, with the edge faces of the side face portion where a semicircular shape is formed by core back, cell density in the semicircular shape portion is higher on the inner side face side. The cell density of the outer side face portion is smaller than the cell density of the inner side face portion, and accordingly, the strength of the outer side face portion which readily receives external force can be increased.

FIG. 9B is a cross section of a molding part representing features of an undercut shape portion of a molding part according to the present invention.

In FIG. 9B, reference numeral 52 denotes a portion formed with a slant core, and reference numeral 51 denotes an undercut shape portion, and reference numeral 53 denotes a side face portion adjacent to the slant core. Also, reference numeral 54 denotes a minute groove emerging on a boundary between the slant core and movable core, and reference numeral 55 indicates internal cells of the movable core portion.

As illustrated in FIG. 9B, the weight reduction ratio of the undercut shape portion forming the slant core can be set to 40% or less as to the weight reduction ratio of the top face portion. With the present invention, the slant core which processes the undercut shape portion of the side face portion can be fixed at the time of core back movement, and accordingly, no foaming in core back operation occurs, and accordingly, internal cell formations are reduced. Therefore, the foaming ratio is lowered at the undercut shape portion 51, and deterioration in strength due to foaming is very small. Accordingly, according to the present invention, the foaming ratio at the undercut shape portion can be suppressed small, whereby the strength of the undercut shape portion can be increased as compared to existing one.

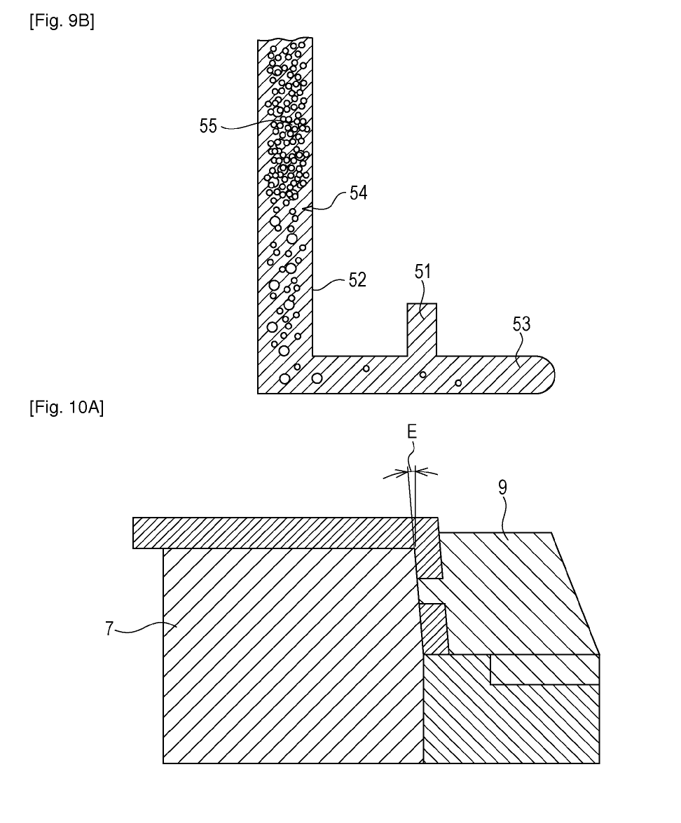

FIG. 10A is a cross-sectional view illustrating a mold configuration to be subjected to undercut shape processing according to the present invention. In FIG. 10A, reference numeral 9 is an outer slide forming an undercut shape, reference numeral 7 is a movable core which performs core back operation, and E indicates a combining slope angle between the outer slide and the movable core.

At the time of filling a foaming resin material within a mold, mold clamping force of a molding machine acts on a mold, and accordingly, the outer slider 9 is pressure welded on the movable core 7. Also, heretofore, the combining slope has 0 degree, and accordingly, the movable core 7 moves while sliding with the outer slide 9 at the time of core back operation.

In the event that pressure welding force from the outer slide to the movable core is strong, the movable core is prevented from moving, and accordingly, core back operation is prevented from being performed. Also, upon forcibly moving the moving core with strong force, this causes a problem in that scraping occurs, and the outer slide and movable core are damaged.

With the present invention, as a feature thereof, a slope indicated with the following expression is provided to a combining slope indicated with E in FIG. 10A.

[Math.2]

0.5 degrees≧E≧5 degrees (Expression 2)

With the present invention, the combining slope E between the outer slide 9 and the movable core 7 illustrated in FIG. 10A is taken as a range of between 0.5 degrees and 5 degrees, and accordingly, the movable core 7 instantly forms a clearance at the time of movement, whereby core back operation can be performed in a smoother manner by preventing occurrence of scraping.

Also, the combining slope is set to a range of between 0.5 degrees and 5 degrees, a resin is prevented from intruding into a clearance between the movable core and slide generated at the time of core back operation (at the time of movement of the second movable-side mold plate), and defective shapes such as occurrence of burring or the like can be prevented.

FIG. 10B is a cross-sectional view illustrating a mold configuration where the undercut shape processing according to the present invention is performed.

In FIG. 10B, reference numeral 58 denotes an outer slide where an undercut shape is formed, reference numeral 7 is a movable core where core back operation is performed, and reference numeral 59 denotes a movable core holding insert block which includes the movable core. Also, reference numeral 60 denotes a core mold plate connecting to the movable core holding insert block in which the outer slide is embedded, reference numeral 4 is a second movable-side mold plate which is connected to the movable core, and moves at the time of core back operation (at the time of movement of the second movable-side mold plate), and reference numeral 2 is a sub parting. At the time of performing core back operation with an existing mold configuration, the movable core 7 moves while sliding with the outer slide 58, which causes a problem in that scraping occurs.

With the present invention, as indicated in F in FIG. 12, a clearance indicated with the following expression is provided in the mold combining portion between the outer slide and movable core.

[Math.3]

0.01 mm≦F≦0.05 mm (Expression 3)

Also, with the present invention, the outer slide 58 is configured to come into contact with the core mold plate 60 at a portion 61, and provides a clearance, denoted by reference numeral 62, along with the movable core holding insert block 59. Therefore, force to be applied to the outer slide at the time of mold clamping is not directly applied to the movable core and movable core holding insert block.

A gap in a range between 0.01 mm and 0.05 mm is taken as a clearance F illustrated in FIG. 10B, and accordingly, at the time of the movable core moving for core back, malfunction of the movable core, and occurrence of damage for a mold such as scraping or the like are further reduced.

Further, with the present invention, the clearance F is managed, and accordingly, at the time of filling a resin and at the time of core back operation, the resin is prevented from entering the clearance portion, and occurrence of burring or the like is prevented, and accordingly, suitable shape precision can be obtained.

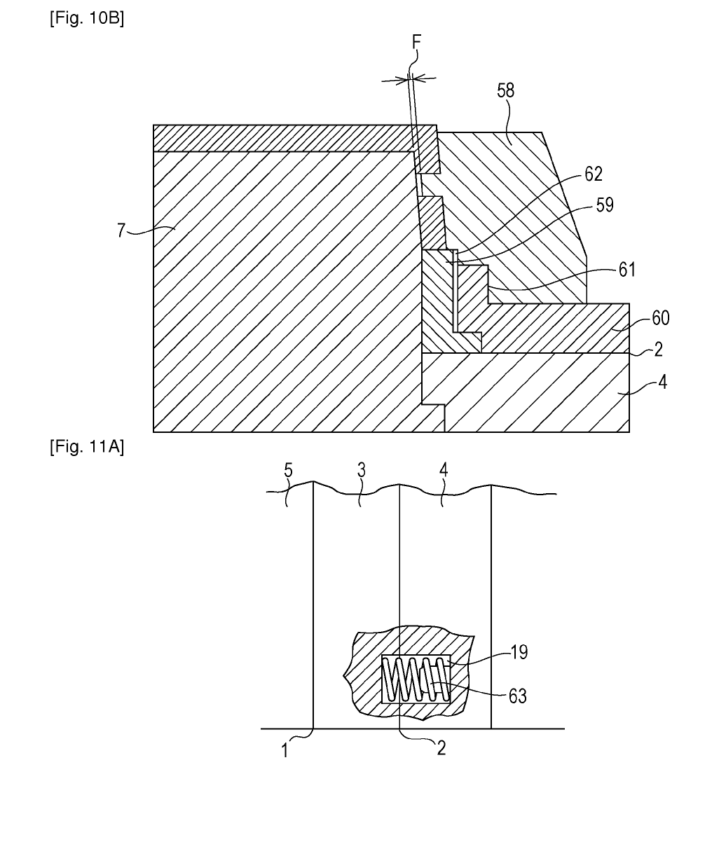

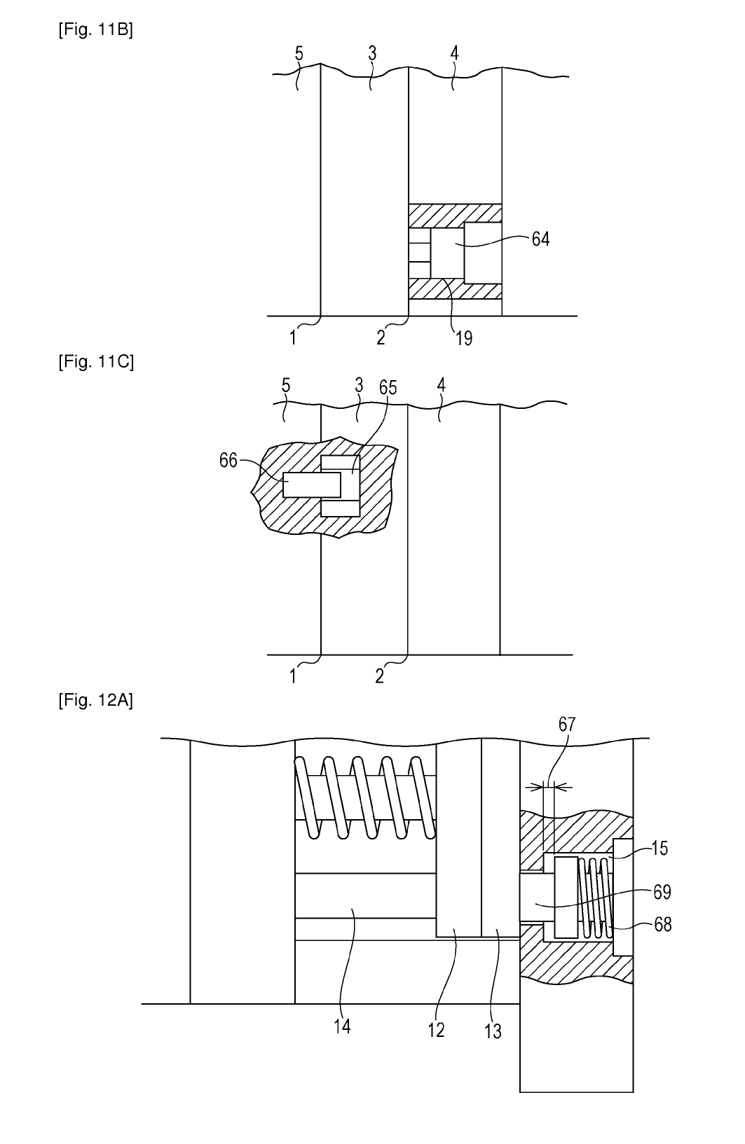

FIG. 11A is a cross-sectional view of a mold for a core mold plate pressing driving unit.

Reference numeral 19 denotes a core mold plate pressing driving unit, and a spring 63 is provided within the unit. At the time of core back operation (at the time of movement of the second movable-side mold plate), the spring 63 presses a movable-side mold plate denoted by reference numeral 3 against a fixed-side mold plate 5, and accordingly, a main parting 1 is not opened. At the same time, the spring 63 attempts to separate the second movable-side mold plate from the movable-side mold plate 3, and accordingly, a sub parting denoted by reference numeral 2 is opened by the worth of core back movement amount.

Accordingly, with the present invention, the spring is provided to a movable-side mold plate driving unit, and accordingly, without opening the main parting at the time of core back operation (at the time of movement of the second movable-side mold plate), the movable core alone can be moved by desired core back amount, and a suitable foam-molding part can be obtained.

FIG. 11B is a cross-sectional view of a mold for a movable-side mold plate pressing driving unit, and is an embodiment wherein a cylinder indicted with reference numeral 64 denotes provided to a driving source. The cylinder 64 selectively uses air driving and hydraulic driving according to the size of a mold, and operation thereof is the same operation as with the driving unit described in FIG. 14.

FIG. 11C is a cross-sectional view of a mold for a main parting fixing unit.

An elastic member 66 is mounted on the main parting fixing unit, which is elastically deformed at the time of the main parting 1 being closed, and implemented in a hole provided to a movable-side mold plate 3. A fixed-side mold plate 5 and the movable-side mold plate 3 are fixed by the force of elastic deformation. Fixing force according to elastic deformation can be changed by regulating elastic deformation amount beforehand, and accordingly, the main parting can be adjusted so as to not open, according to the size or weight of mold at the time of core back operation (at the time of movement of the second movable-side mold plate).

With the present invention, at the time of core back operation (at the time of movement of the second movable-side mold plate), at least one unit of the units illustrated in FIGS. 1, 11A, 11B, and 11C is mounted so as to prevent the main parting from being opened according to need. However, all of these do not necessarily have to be used according to the size or the like of a mold.

FIG. 12A is a cross-sectional view of a mold for an ejector plate driving unit.

In FIG. 12A, reference numeral 15 denotes an ejector plate driving unit, where a spring denoted by reference numeral 68 and a movable pin denoted by reference numeral 69 are included in the driving unit.

A state before core back operation after resin filling is a state illustrated in FIG. 12A, the first ejector plate 12 and second ejector plate 13 are positioned on the fixed-side attachment plate by the return pin 14. The movable pin 69 presses the second ejector plate 13 using the spring 68, but the pressing force of the return pin is stronger, and accordingly, the second ejector plate 13 is positioned in a state compressing the spring by core back amount gap worth denoted by reference numeral 67.

At the time of core back operation, the return pin attempts to separate from the first ejector plate 12 in the cavity plate direction by core back amount worth. However, the spring of the ejector plate driving unit according to the present invention presses the movable pin 69, and accordingly, the movable pin 69 presses the second ejector plate 13, and moves by the core back amount gap worth denoted by reference numeral 67.

Therefore, according to the present invention, the ejector plates can maintain positions thereof by the ejector plate driving unit at the time of core back, and accordingly, the slant core and ejector pin connected to the ejector plates are prevented from moving.

FIG. 12B is an embodiment employing a cylinder as the driving source of the ejector plate driving unit illustrated in FIG. 12A.

In FIG. 12B, reference numeral 70 denotes a cylinder, the cylinder selectively uses air driving and hydraulic driving according to the size of a mold, and operation thereof is the same operation as with the driving unit described in FIG. 12A.

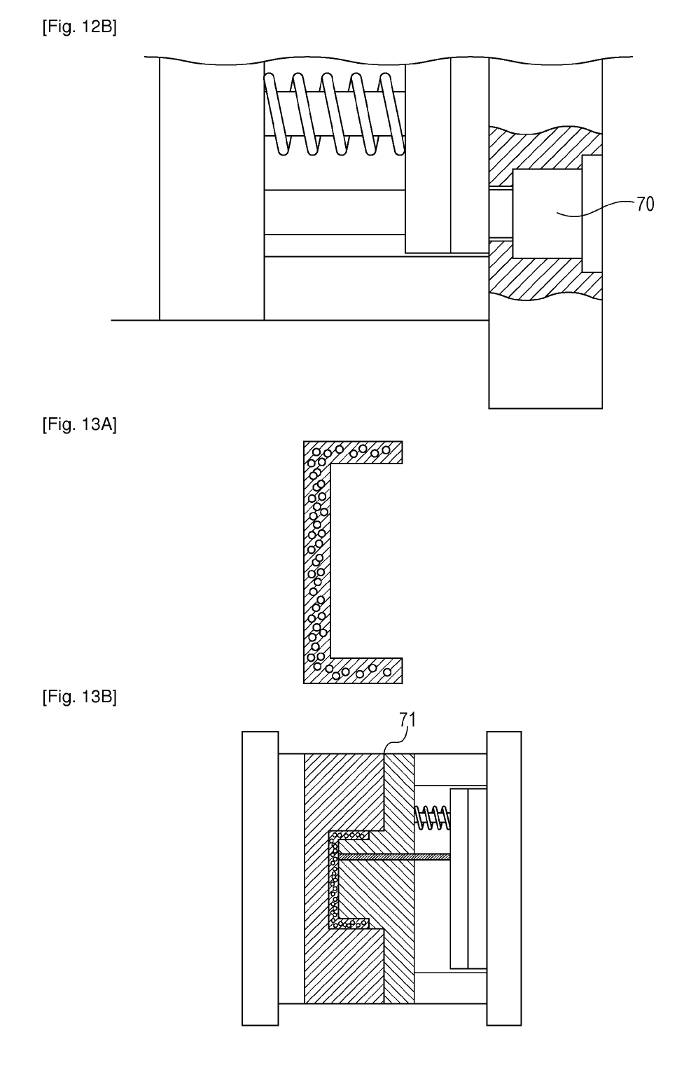

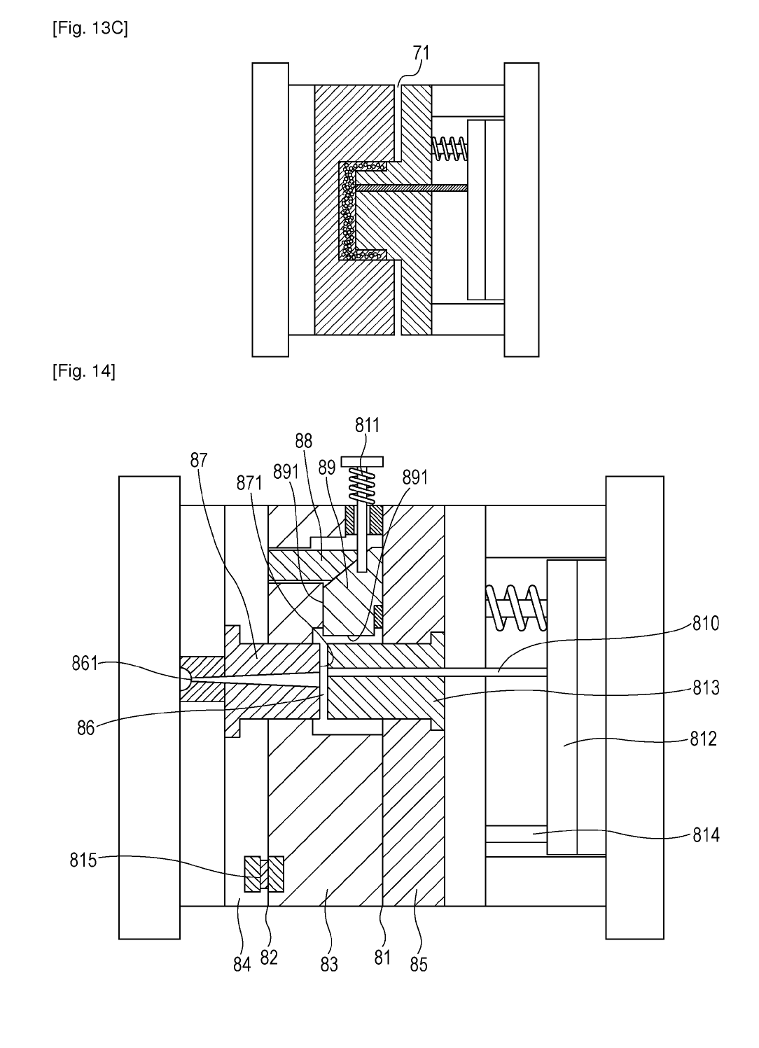

FIG. 13A is a cross-sectional view of an existing foam-molding part.

With an existing mold configuration, it is difficult to perform the undercut processing, and forming of a punching hole, a nipping shape, a curvature of the side face portion, or the like, and accordingly, this is a configuration wherein the movable side of the entire molding part is subjected to core back movement by the main parting alone. As a result thereof, the internal configuration of a molding part forms generally the same foaming configuration at the cross-sectional portion subject to core back movement, as illustrated in FIG. 12.

FIG. 13B is a configuration diagram of an existing mold, and is a cross-sectional view of the mold immediately after a foaming resin material is filled in the mold. FIG. 13C illustrates a state in which core back operation has been performed at a mold having an existing configuration, and one mold parting denoted by reference numeral 71 is employed.

With an existing mold configuration, one main parting is employed, and accordingly, the entirety of the movable side of a mold moves at the time of core back operation.

Therefore, the component edge face is configured of a mold plate on the fixed side and a mold plate on the movable side being combined with a fitting configuration illustrated in FIG. 13B.

The mold configuration of the side face portion has a fitting configuration, and accordingly, with the edge faces of the side face portion, a circular shape can be added to only the outer side or inner side, and a curvature (semicircular shape) is not added to the side face portion unlike the present invention.

Further, with an exiting mold configuration, the entirety of the mold on the movable side moves at the time of core back movement, and accordingly, in the event that a component includes a punching hole, nipping shape, or undercut shape, a gap is opened in a mold simultaneously with movement of a core, and accordingly, burring occurs, or shape damage or the like occurs at a slant core portion. Therefore, with an existing mold configuration, it has been difficult to perform the undercut processing, and forming of a punching hole, a nipping shape, curvature (semicircular shape) of the side face portion, or the like.

As described above, a pushing-cut hold and a nipping hole which have to be molded as molding parts are connected to a punching insert block and a nipping insert block, the punching insert block and nipping insert block are moved in the core back direction by the driving unit according to a spring or the like to maintain positions thereof before core back operation. Therefore, there is no occurrence of burring in the punching hole and nipping hole portions, and shape precision can be improved.

Also, according to the present invention, the curvature (semicircular shape) can be processed on the side face portion, which has heretofore been impossible. With an armored cover or a component which a user handles, curvature adding is needed to prevent user damage, and according to the present invention, application use can be expanded to components which are needed for full R (semicircular shape) processing.

Further, with regard to the undercut shape portion, the driving unit such as a spring or the like is provided within a sub parting on the movable side so as to be in conjunction with the operation of the main parting regarding the outer slide portion, and accordingly, a position thereof is prevented from moving at the time of core back operation (at the time of movement of the second movable-side mold plate). Therefore, there is no occurrence of burring, and more suitable shape precision can be obtained as compared to an existing configuration. Also, the side face portion has an undercut, which is configured wherein, with a shape which has to be processed at a slant core, the slant core is connected to an ejector plate, and the ejector plate is sandwiched by a return pin and a driving unit such as a spring or the like provided within a movable-side attachment plate. Therefore, the position of the slant core is prevented from moving at the time of core back operation (at the time of movement of the second movable-side mold plate), and accordingly, deformation or damage of a slant shape portion which has occurred with an existing mold configuration is prevented from occurring. Also, there is no occurrence of burring, and a more suitable shape precision can be obtained as compared to an existing configuration.

### Second Embodiment

In the first embodiment, an embodiment is described wherein a movable-side plate is divided into multiple plates, and a sub parting that opens at the time of core back operation (at the time of movement of a second movable-side mold plate) is provided on the movable side. Similarly, dividing a fixed-side plate into multiple plates and providing a sub parting on the fixed side can also express similar advantages.

In FIG. 14, reference numeral 81 denotes a main parting, and 82 denotes a contact face between fixed-side mold plates of the fixed-side mold plates divided into multiple plates, and is a sub parting which is opened for a predetermined amount of time at the time of core back operation. Reference numeral 83 denotes a fixed-side mold plate making up the main parting using a contact face with a movable-side mold plate. The fixed-side mold plate 83 is movable in the mold opening direction and in the parallel direction of the movable-side mold plate, in conjunction with the core back operation. Reference numeral 84 denotes a second fixed-side mold plate, on which a movable core is fixed, and can be separated from the fixed-side mold plate 83. The movable core can be moved relative as to the cavity, by separating leaving a predetermined amount of space between the fixed-side mold plate 83 at the time of core back operation. Reference numeral 85 denotes a movable-side mold plate, and reference numeral 86 denotes a foam-molding parts shape portion (cavity) formed within a mold. Reference numeral 861 denotes a resin injection hole for injecting a foaming resin into the cavity 86. As for a foaming resin to be injected into the cavity, a resin which has commonly been employed can be employed. For example, there can be employed a resin into which a foaming agent such as butane gas, methane gas, water, nitrogen, carbon dioxide gas, or the like is infiltrated, a resin to which melt kneading or chemical reaction is mechanically induced, or a resin into which nitrogen or carbon dioxide gas in a supercritical state under high-pressure high temperature is infiltrated, or the like.

Also, reference numeral 87 denotes a movable core which performs core back operation, a surface 871 thereof makes up a portion of the cavity. Reference numeral 810 denotes an ejector pin.

Reference numeral 812 denotes an ejector plate which connects to the ejector pin, and reference numeral 813 denotes a core which forms a movable-side forming portion. Also, reference numeral 814 is a return pin which returns the ejector plate to a predetermined position at the time of mold clamping.

Reference numeral 815 denotes a fixed-side mold plate press driving unit that pressed the fixed-side mold plate 85 toward the movable-side mold plate 83 side at the time of core back operation (at the time of operation of the second fixed-side mold plate).

At the time of core back operation, the sub parting 82 which is a contact face between the movable-side mold plate 83 and the second fixed-side mold plate 84 is opened, and the movable core 87 moves along with the sub parting in the direction of expanding the cavity capacity.

Also, a configuration may be made wherein, at the same time that the sub parting opens, another core (insert block) that is separate from the movable core can be moved in the direction of increasing cavity capacity, whereby the cavity capacity for forming molding parts can be increased, and foaming is facilitated. In FIG. 14, reference numeral 89 denotes an insert block (here, called an outer slide) that has an undercut shape and is connected to the movable-side mold plate 85, and operates in conjunction with the opening/closing of the main parting, and the surface 891 thereof forms a portion of the cavity. At this time, the main parting does not open due to the fixed-side mold plate pressing driving unit 815 pressing the fixed-side mold plate 3 onto the movable-side mold plate 85.

Also, in the event of the sub parting 82 opening, the outer slide 89 moves toward a slide support 88 connected to the second fixed-side mold plate mold opening direction, and the outer slide moves in the direction of expanding the cavity capacity by a slide spring 811. The ejector 810 connected to the ejector plate does not operate during the core back operation.

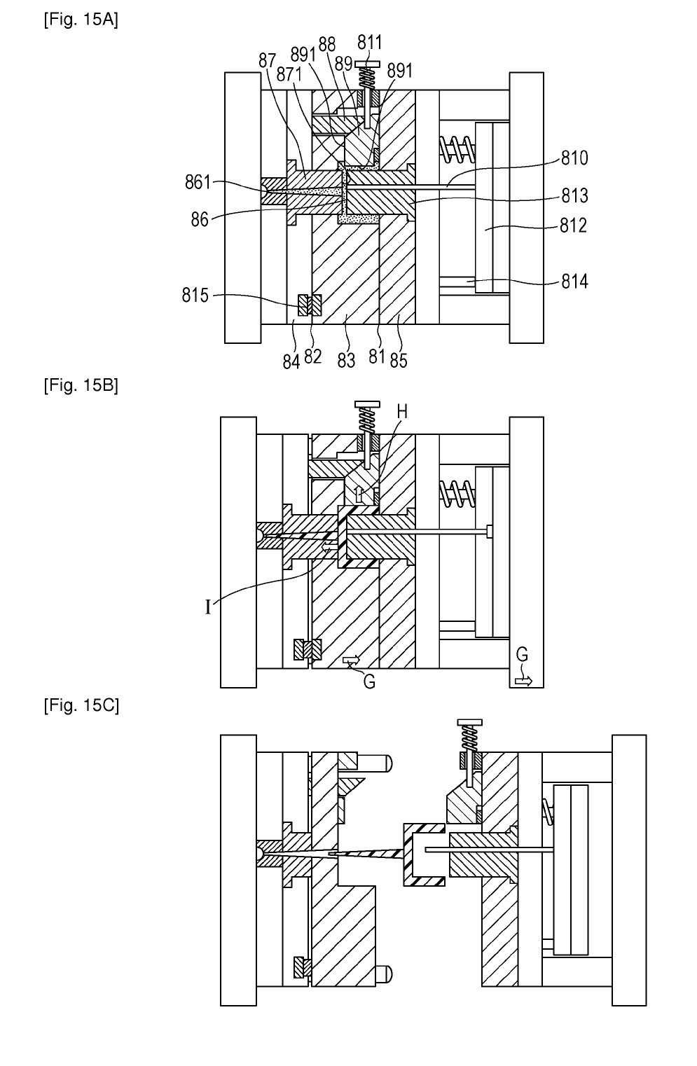

Next, a mold operation according to the present invention will be described with reference to FIG. 15. The members that are the same as FIG. 14 will have the same reference numerals appended thereto, and the description thereof will be omitted.

FIG. 15A illustrates a state immediately following the foaming resin having filled the mold, and the main parting of 81 and sub parting shown by 82 are in a closed state.

After the foaming resin is filled, as illustrated in FIG. 15B, a mold attachment plate on the movable side (commonly referred to as movable-side platen) is moved by predetermined core back amount under the control on the molding machine side.

According to this operation, the movable-side mold plate and fixed-side mold plate are moved in the mold-opening direction G, and the second movable-side mold plate 84 and the movable core 87 fixed in the second movable-side mold plate 84 are moved by the same amount as to the cavity, relative to the direction of increasing the cavity capacity (here, the opposite direction I as the mold-opening direction). Also, At the same time that the sub parting is opened, the outer slide also is moved in the direction H of increasing the cavity capacity.

In FIG. 15B, at the time of core back operation, the fixed-side mold plate press driving unit 915 provided in the second fixed-side mold plate 94 pressed the fixed-side mold plate 93 toward the main parting, so that the main parting does not open. According to this operation, the main parting does not open at the time of core back operation.

Accordingly, with the mold configuration according to the present invention, the main parting is not opened at the time of core back operation, and accordingly, occurrence of burring is prevented in the main parting area, and a foam-molding part having suitable shape precision can be obtained.

FIG. 15C illustrates operation at the time of taking out a component after cooling of the resin within the mold. According to the mold opening operation of the molding machine, the main parting is opened, a molding machine ejector rod is advanced, the ejector plates 912 are pushed out, and the molding part is taken out.

### Embodiment 1 Through Embodiment 5

Molding was performed using a mold according to the present invention (mold having a curvature on the side face portion described in FIG. 8) under molding conditions described in Table 1. Also, molding results are also described in Table 1.

TABLE 1

| | Embodiment 1 | Embodiment 2 | Embodiment 3 | Embodiment 4 | Embodiment 5 |
|---|---|---|---|---|---|
| Resin material | PC + ABS | PC + ABS | PC + ABS | PC + ABS | PC + ABS |
| Foaming agent | nitrogen | nitrogen | nitrogen | nitrogen | nitrogen |
| Resin | 250° C. | 250° C. | 250° C. | 250° C. | 250° C. |
| temperature | | | | | |
| Mold | 50° C. | 50° C. | 50° C. | 50° C. | 50° C. |
| temperature | | | | | |
| Filling time | 1.5 sec | 1.5 sec | 1.5 sec | 1.5 sec | 1.8 sec |
| Pressure | 0.8 sec | 0.8 sec | 0.8 sec | 0.8 sec | 0.8 sec |
| keeping time | | | | | |
| Pressure | 70 MPa | 70 MPa | 70 MPa | 70 MPa | 50 MPa |
| keeping force | | | | | |
| Cooling time | 12 sec | 12 sec | 12 sec | 12 sec | 12 sec |
| Core back time | 0.5 sec | 0.5 sec | 0.5 sec | 0.5 sec | 0.5 sec |
| Core back start | 0.6 sec from | 0.6 sec from | 0.6 sec from | 0.6 sec from | 0.6 sec from |
| timing | V-P switching | V-P switching | V-P switching | V-P switching | V-P switching |
| Core back | 0.6 mm | 0.6 mm | 0.6 mm | 0.6 mm | 0.8 mm |
| movement | | | | | |
| amount | | | | | |
| Initial top face | 1.2 mm | 1.2 mm | 1.2 mm | 1.2 mm | 1.5 mm |
| portion thickness | | | | | |
| Side face portion | 1.9 mm | 2.0 mm | 2.3 mm | 2.5 mm | 2.5 mm |
| thickness | | | | | |
| Slide combining | 0 degree | 0 degree | 0.5 degrees | 3.0 degrees | 5.0 degrees |
| slope | | | | | |
| Shape precision | good | very good | very good | very good | very good |
| Mold damage | good | good | very good | very good | very good |

Molding was performed under the conditions in Table 1 using a foaming resin material wherein a PC+ABS resin is melted within a mold cylinder, nitrogen gas is injected into the melted resin material under high pressure, and nitrogen is melted as a foaming agent. Note that the employed molding machine was a JSW350 Ton molding machine.

With Embodiment 3 through Embodiment 5, with regard to the initial top face portion thickness, side face portion thickness, and slide combining slope, a mold was manufactured in accordance with the above-mentioned embodiment. As a result thereof, an R shape without steps was formed on the side face portion, and no mold burring occurred.

With Embodiment 1 and Embodiment 2, a mold without slid combining slope was manufactured, and molding was performed. With Embodiment 1, a minute step occurred on a portion of the edge face, and with Embodiment 1 and Embodiment 2, there was mild mold burring on a portion thereof. However, neither of those is sufficient to cause a problem in the quality.

Also, any of Embodiments 1 through 5 had a configuration illustrated in FIGS. 2B, 11, and 12, the foaming state of the side face portion was a state in which the foaming ratio is lower than that of the top face portion, and deterioration in strength due to foaming is small.

### Embodiment 6 Through Embodiment 10

Molding was performed using a mold according to the present invention (mold having a curvature on the side face portion described in FIG. 8) under molding conditions described in Table 2. Also, molding results are also described in Table 2.

TABLE 2

| | | | | | Embodiment |
|---|---|---|---|---|---|
| | Embodiment 6 | Embodiment 7 | Embodiment 8 | Embodiment 9 | 10 |
| Resin material | PPE + PS | PPE − PS | PBT − GF30 | PBT − GF30 | PBT − GF30 |
| Foaming agent | nitrogen | nitrogen | nitrogen | nitrogen | nitrogen |
| Resin | 300° C. | 300° C. | 260° C. | 260° C. | 260° C. |
| temperature | | | | | |
| Mold temperature | 60° C. | 60° C. | 80° C. | 80° C. | 80° C. |
| Filling time | 1.5 sec | 1.5 sec | 1.2 sec | 1.2 sec | 1.2 sec |
| Pressure keeping | 0.8 sec | 0.8 sec | 0.6 sec | 0.6 sec | 0.6 sec |
| time | | | | | |
| Pressure keeping | 70 MPa | 70 MPa | 50 MPa | 50 MPa | 50 MPa |
| force | | | | | |
| Cooling time | 12 sec | 12 sec | 10 sec | 10 sec | 10 sec |
| Core back time | 0.6 sec | 0.6 sec | 0.5 sec | 0.5 sec | 0.5 sec |
| Core back start | 0.6 sec from | 0.6 sec from | 0.5 sec from | 0.5 sec from | 0.5 sec from |
| timing | V-P switching | V-P switching | V-P switching | V-P switching | V-P switching |
| Core back | 0.9 mm | 0.8 mm | 0.6 mm | 1.3 mm | 0.5 mm |
| movement | | | | | |
| amount | | | | | |
| Initial top face | 1.2 mm | 1.5 mm | 1.2 mm | 1.2 mm | 1.5 mm |
| portion thickness | | | | | |
| Side face portion | 2.1 mm | 1.5 mm | 2.0 mm | 2.5 mm | 1.8 mm |
| thickness | | | | | |
| Slide combining | 1.0 degree | 3.0 degrees | 0.5 degrees | 3.0 degrees | 5.0 degrees |
| slope | | | | | |
| Shape precision | good | very good | very good | very good | very good |
| Mold damage | good | good | very good | very good | very good |

With Embodiment 1 through Embodiment 5, a PC+ABS resin was employed, but here, core back molding was performed with a resin material of PPE+PS, and a material including 30% of PBT glass fiber.

With any of the Embodiments, the slide combining slope was 0.5 degrees or more, and no mold damage was not observed even when performing core back operation.

With Embodiment 7 and Embodiment 10 wherein the thickness of the side face portion is thinner than 2 mm, a minute step occurred on a portion of the edge face, which was not enough to cause a problem regarding quality.

This occurrence of a minute step can be conceived because the cooling speed of the edge faces of the side face portion was fast, the resin viscosity was increased due to cooling, and accordingly, at the time of core back operation, the resin did not move following the surface of a mold performing core back.

With Embodiments 6, 8, and 9, the thickness of the side face portion was thicker than the initial thickness of the top face portion, and also equal to or greater than 2 mm. The viscosity increase speed at the time of cooling of the side face portion was able to be smaller than that of the top face portion at the time of core back operation (at the time of movement of the second movable-side mold plate) of the top face portion, and accordingly, the resin followed the mold surface performing core back, and a very suitable shape was obtained.

Also, with the present invention, as indicated in Embodiments 8 and 9, it was found that a foaming component with high shape precision is obtained by performing the foam-mold and manufacturing method according to the present invention on even a material including glass filler of which the viscosity increase speed at the time of cooling is fast.

### Embodiment 11 Through Embodiment 13, Comparative Example 1

Molding was performed using a mold according to the present invention (mold having a curvature on the side face portion described in FIG. 8) under molding conditions described in Table 3. Also, molding results are also described in Table 3.

TABLE 3

| | Comparative | Embodiment | Embodiment | Embodiment |
|---|---|---|---|---|
| | Example 1 | 11 | 12 | 13 |
| Resin material | PC + ABS | PC + ABS | PC + ABS | PC + ABS |
| Foaming agent | None | nitrogen | nitrogen | nitrogen |
| Resin temperature | 250° C. | 250° C. | 250° C. | 250° C. |
| Mold temperature | 50° C. | 50° C. | 50° C. | 50° C. |
| Filling time | 1.5 sec | 1.5 sec | 1.5 sec | 1.5 sec |
| Pressure keeping time | 0.8 sec | 0.8 sec | 0.8 sec | 0.8 sec |
| Pressure keeping force | 70 MPa | 70 MPa | 70 MPa | 70 MPa |
| Cooling time | 12 sec | 12 sec | 12 sec | 12 sec |
| Core back time | none | 0.5 sec | 0.6 sec | 0.7 sec |
| Core back start timing | none | 0.6 sec from | 0.6 sec from | 0.6 sec from |
| | | V-P switching | V-P switching | V-P switching |
| Core back movement | none | 0.6 mm | 0.8 mm | 1.0 mm |
| amount | | | | |
| Initial top face portion | 2.0 mm | 1.4 mm | 1.6 mm | 1.6 mm |
| thickness | | | | |
| Side face portion | 2.0 mm | 2.0 mm | 2.0 mm | 2.0 mm |
| thickness | | | | |
| Slide combining slope | 0.5 degrees | 0.5 degrees | 0.5 degrees | 0.5 degrees |
| Shape precision | very good | very good | very good | very good |
| Mold damage | very good | very good | very good | very good |
| Top face portion rigidity | Reference | 30% lowering | 0% lowering | 5% lowering |
| | value | | | |
| Edge face shape | Reference | 5% lowering | 6% lowering | 6% lowering |
| portion rigidity | value | | | |
| Deformation amount | 4 mm | 4.8 mm | 4.1 mm | 3.8 mm |
| Foaming ratio | Reference | 1.28 | 1.24 | 1.24 |
| | value | | | |

With Table 3, the rigidity and deformation amount evaluations were measured by applying load of 300 g to the center of the top face portion of a box shape of width 250 mm*depth 250 mm*height 40 mm. Also, Comparative Example 1 is a normal molding part, and the rigidities of Embodiments 11 through 13 were compared with the rigidity of the normal molding part serving as a reference.

As results of Table 3, at the time of performing the foam-mold and manufacturing method according to the present invention, as indicated in Embodiment 13, the deformation amount was able to be reduced as compared to the normal molding part while performing 24% weight reduction by selecting suitable thickness and core back amount before core back operation.

According to Embodiments of the present invention in Table 3, the initial thickness, and the final thickness after core back operation were set to predetermined amount, the punching hole, nipping shape, undercut shape portion, and edge faces of the side face portion were configured of a foam-mold according to the present invention, and subjected to molding, and accordingly, damage of a mold did not occur.

Also, since there was no occurrence of burring, a molding part with high shape precision and also with both of weight reduction and rigidity was able to be obtained.

### Embodiment 14 Through Embodiment 17

Molding was performed using a mold according to the present invention (mold having a curvature on the side face portion described in FIG. 8) under molding conditions described in Table 4. Also, molding results are also described in Table 4.

TABLE 4

| | Embodiment | Embodiment | Embodiment | Embodiment |
|---|---|---|---|---|
| | 14 | 15 | 16 | 17 |
| Resin material | PC + ABS | PC + ABS | PC + ABS | PC + ABS |
| Foaming agent | nitrogen | nitrogen | nitrogen | nitrogen |
| Resin temperature | 250° C. | 250° C. | 250° C. | 250° C. |
| Mold temperature | 50° C. | 50° C. | 50° C. | 50° C. |
| Filling time | 1.5 sec | 1.5 sec | 1.5 sec | 1.5 sec |
| Pressure keeping | 0.8 sec | 0.8 sec | 0.8 sec | 0.8 sec |
| time | | | | |
| Pressure keeping | 70 MPa | 70 MPa | 70 MPa | 70 MPa |
| force | | | | |
| Cooling time | 12 sec | 12 sec | 12 sec | 12 sec |
| Core back time | 0.6 sec | 0.6 sec | 0.6 sec | 0.6 sec |
| Core back start | 0.6 sec from | 0.6 sec from | 0.6 sec from | 0.6 sec from |
| timing | V-P switching | V-P switching | V-P switching | V-P switching |
| Core back | 0.8 mm | 0.8 mm | 0.8 mm | 0.8 mm |
| movement amount | | | | |
| Initial top face | 1.5 mm | 1.5 mm | 1.5 mm | 1.5 mm |
| portion thickness | | | | |
| Side face portion | 2.3 mm | 2.3 mm | 2.3 mm | 2.3 mm |
| thickness | | | | |
| Slide combining | 0.0 mm | 0.01 mm | 0.05 mm | 0.06 mm |
| clearance | | | | |
| Shape precision | very good | very good | very good | very good |
| Mold damage | very good | very good | very good | very good |

The mold clamping force was 300 t, and mold compression deformation amount due to the mold clamping force was 0.02 mm.

In Table 4, with Embodiments 15 and 16 wherein a clearance between the slide and movable core indicted with H in FIG. 13 was set to 0.01 mm and 0.05 mm, a molding part without occurrence of burring or scraping was able to be obtained.

With Embodiment 14, clearance was set to zero. Minute scraping, not enough to cause a problem regarding quality occurred at the mold the time of the movable core moving. Also, as with Embodiment 17, in the event that clearance was set to 0.06 mm, though not enough to cause a problem regarding quality, little burring occurred between the slide and movable core.

### Embodiment 18 Through Embodiment 21

Molding was performed using a mold according to the present invention (mold having a curvature on the side face portion described in FIG. 8) under molding conditions described in Table 5. Also, molding results are also described in Table 5.

TABLE 5

| | Embodiment | Embodiment | Embodiment | Embodiment |
|---|---|---|---|---|
| | 18 | 19 | 20 | 21 |
| Resin material | PC + ABS | PPE − PS | PBT − GF30 | ABS |
| Foaming agent | nitrogen | nitrogen | nitrogen | nitrogen |
| Resin temperature | 250° C. | 300° C. | 260° C. | 210° C. |
| Mold temperature | 50° C. | 60° C. | 80° C. | 40° C. |
| Filling time | 1.5 sec | 1.5 sec | 1.2 sec | 1.0 sec |
| Pressure keeping | 0.8 sec | 0.8 sec | 0.6 sec | 0.6 sec |
| time | | | | |
| Pressure keeping | 70 MPa | 70 MPa | 50 MPa | 50 MPa |
| force | | | | |
| Cooling time | 12 sec | 12 sec | 10 sec | 14 sec |
| Core back time | 0.6 sec | 0.6 sec | 0.5 sec | 0.5 sec |
| Core back start timing | 0.6 sec from | 0.6 sec from | 0.5 sec from | 0.8 sec from |
| | V-P switching | V-P switching | V-P switching | V-P switching |
| Core back movement | 0.8 mm | 0.8 mm | 0.6 mm | 0.8 mm |
| amount | | | | |
| Initial top face portion | 1.5 mm | 1.5 mm | 1.2 mm | 1.2 mm |
| thickness | | | | |
| Side face portion | 2.0 mm | 2.1 mm | 2.0 mm | 2.0 mm |
| thickness | | | | |
| Slide combining slope | 1 degree | 1 degree | 1 degree | 1 degree |
| Shape precision | very good | very good | very good | very good |
| Mold damage | very good | very good | very good | very good |
| Top face portion | 28% | 30% | 25% | 26% |
| weight reduction ratio | | | | |
| Side face portion | 11% | 14% | 8% | 9% |
| weight reduction ratio | | | | |

According to Embodiment 18 through Embodiment 21 of the present invention indicated in Table 5, in the case of molding using the foam-mold and manufacturing method according to the present invention, with all of the four types of materials, the weight reduction ratio of the side face portion as to the weight reduction ratio of the top face portion having the thickness in the core back movement direction was 50% or less. Accordingly, the foaming ratio of the side face portion was controlled by performing the mold configuration and manufacturing method according to the present invention, whereby deterioration in strength due to foaming was able to be reduced to a small value.

Note that it is common knowledge that mechanical strength such as an elastic ratio or tensile strength or the like is reduced along with increase in the foaming ratio or weight reduction ratio.

### Embodiment 22 Through Embodiment 25

Results of molding using the molds described in FIGS. 1 and 3 of the present invention will be indicted in Table 6.

TABLE 6

| | Embodiment | Embodiment | Embodiment | Embodiment |
|---|---|---|---|---|
| | 22 | 23 | 24 | 25 |
| Resin material | PC + ABS | PPE − PS | PBT − GF30 | ABS |
| Foaming agent | nitrogen | nitrogen | nitrogen | nitrogen |
| Resin temperature | 250° C. | 300° C. | 260° C. | 210° C. |
| Mold temperature | 50° C. | 60° C. | 80° C. | 40° C. |
| Filling time | 1.5 sec | 1.5 sec | 1.2 sec | 1.0 sec |
| Pressure keeping | 0.8 sec | 0.7 sec | 0.6 sec | 0.3 sec |
| time | | | | |
| Pressure keeping | 70 MPa | 70 MPa | 50 MPa | 50 MPa |
| force | | | | |
| Cooling time | 12 sec | 12 sec | 10 sec | 14 sec |
| Core back time | 0.6 sec | 0.6 sec | 0.5 sec | 0.5 sec |
| Core back start | 0.6 sec from | 0.7 sec from | 1.0 sec from | 0.5 sec from |
| timing | V-P switching | V-P switching | V-P switching | V-P switching |
| Core back movement | 0.8 mm | 0.8 mm | 0.6 mm | 0.8 mm |
| amount | | | | |
| Initial top face portion | 1.5 mm | 1.5 mm | 1.2 mm | 1.2 mm |
| thickness | | | | |
| Side face portion | 2.0 mm | 2.1 mm | 2.0 mm | 2.0 mm |
| thickness | | | | |
| Slide combining | 1 degree | 1 degree | 1 degree | 1 degree |
| slope | | | | |
| Shape precision | very good | very good | very good | very good |
| Slant core boundary | Width 0.15 | Width 0.21 | Width 1.50 mm | Width 0.02 |
| step | Depth 0.10 | Depth 0.25 | Depth 0.50 mm | Depth 0.02 |
| Mold damage | very good | very good | very good | very good |
| Top face portion | 28% | 30% | 25% | 26% |
| weight reduction ratio | | | | |
| Slant portion weight | 7% | 9% | 6% | 6% |
| reduction ratio | | | | |

As indicted in Table 6, in the case of molding using the foam-mold and manufacturing method according to the present invention, with all of the four types of materials, the weight reduction ratio of the undercut edge face shape portion made up of the slant core as to the weight reduction ratio of the top face portion having the thickness in the core back movement direction was 40% or less. Accordingly, according to the present invention, the foaming ratio of the undercut edge face shape portion made up of the slant core was controlled, whereby deterioration in strength due to foaming was able to be reduced to a small value.

Also, with the four types of materials in the boundary between the slant core and the movable core, the width was 0.02 mm through 1.5 mm, and the depth was 0.02 mm through 0.5 mm.

Note that a minute step formed on the boundary between the slant core and the movable core which is a feature of the molding part according to the present invention was minute as indicated in Embodiment 22 through Embodiment 25, and influence on the shape precision and component strength was very small.

### Embodiment 26 Through Embodiment 29

Results of molding using molds forming the punching insert block and nipping insert block described in FIG. 6 as to the mold in FIG. 1 according to the present invention will be indicated in Table 7.

TABLE 7

| | Embodiment | Embodiment | Embodiment | Embodiment |
|---|---|---|---|---|
| | 26 | 27 | 28 | 29 |
| Resin material | PC + ABS | PPE − PS | PBT − GF30 | ABS |
| Foaming agent | nitrogen | nitrogen | nitrogen | nitrogen |
| Resin temperature | 250° C. | 300° C. | 260° C. | 210° C. |
| Mold temperature | 50° C. | 60° C. | 80° C. | 40° C. |
| Filling time | 1.5 sec | 1.5 sec | 1.2 sec | 1.0 sec |
| Pressure keeping | 0.8 sec | 0.7 sec | 0.6 sec | 0.3 sec |
| time | | | | |
| Pressure keeping | 70 MPa | 70 MPa | 50 MPa | 50 MPa |
| force | | | | |
| Cooling time | 12 sec | 12 sec | 10 sec | 14 sec |
| Core back time | 0.6 sec | 0.6 sec | 0.5 sec | 0.5 sec |
| Core back start | 0.6 sec from | 0.7 sec from | 1.0 sec from | 0.5 sec from |
| timing | V-P switching | V-P switching | V-P switching | V-P switching |
| Core back movement | 0.8 mm | 0.8 mm | 0.6 mm | 0.8 mm |
| amount | | | | |
| Initial top face portion | 1.5 mm | 1.5 mm | 1.2 mm | 1.2 mm |
| thickness | | | | |
| Side face portion | 2.0 mm | 2.1 mm | 2.0 mm | 2.0 mm |
| thickness | | | | |
| Slide combining | 1 degree | 1 degree | 1 degree | 1 degree |
| slope | | | | |
| Shape precision | very good | very good | very good | very good |
| Punching insert block | Width 0.15 | Width 0.21 | Width 1.50 mm | Width 0.02 |
| boundary step | Depth 0.10 | Depth 0.25 | Depth 0.50 mm | Depth 0.02 |
| Nipping insert block | Width 0.15 | Width 0.21 | Width 1.50 mm | Width 0.02 |
| boundary step | Depth 0.10 | Depth 0.25 | Depth 0.50 mm | Depth 0.02 |
| Mold damage | very good | very good | very good | very good |

The steps in the boundaries between the punching insert block, nipping insert block, and movable core were, with the four types of materials, 0.02 mm through 1.5 mm in width, and 0.02 mm through 0.5 mm in depth, which were the same step amount as the step between the slant core and movable core according to the present invention indicated in the embodiments in the above Table 6.

As with the step at the slant core, a minute step formed on the boundaries between the punching insert block, nipping insert block, and movable core which is a feature of the molding part according to the present invention was minute as indicated in Embodiment 26 through Embodiment 29, and influence on the shape precision and component strength was very small.

Note that, with other than the materials indicated in the Embodiments of the present invention in Tables 1 through 7, the present invention is effective as to existing techniques, and accordingly, the present invention is not restricted to the range indicated with the Embodiments.

### Embodiment 30 Through Embodiment 34

Molding was performed using a mold according to the present invention (mold described in FIG. 14) under molding conditions described in Table 8. Also, molding results are also described in Table 8.

TABLE 8

| | Embodiment | Embodiment | Embodiment | Embodiment | Embodiment |
|---|---|---|---|---|---|
| | 30 | 31 | 32 | 33 | 34 |
| Resin material | PC + ABS | PC + ABS | PC + ABS | PBT − GF30% | PPE + PS |
| Foaming agent | nitrogen | nitrogen | nitrogen | nitrogen | nitrogen |
| Resin | 250° C. | 250° C. | 250° C. | 270° C. | 300° C. |
| temperature | | | | | |
| Mold | 50° C. | 50° C. | 50° C. | 80° C. | 35° C. |
| temperature | | | | | |
| Filling time | 1.0 sec | 1.0 sec | 1.0 sec | 0.8 sec | 1.5 sec |
| Pressure | 0.5 sec | 0.5 sec | 0.5 sec | 0.5 sec | 0.6 sec |
| keeping time | | | | | |
| Pressure | 60 MPa | 60 MPa | 60 MPa | 70 MPa | 50 MPa |
| keeping force | | | | | |
| Cooling time | 12 sec | 12 sec | 12 sec | 8 sec | 10 sec |
| Core back time | 0.5 sec | 0.5 sec | 0.5 sec | 0.5 sec | 0.5 sec |
| Core back start | 0.6 sec from | 0.6 sec from | 0.6 sec from | 0.6 sec from | 0.6 sec from |
| timing | V-P switching | V-P switching | V-P switching | V-P switching | V-P switching |
| Core back | 0.5 mm | 1.0 mm | 2.0 mm | 0.5 mm | 0.8 mm |
| movement | | | | | |
| amount | | | | | |
| Initial top face | 1.2 mm | 1.5 mm | 2.0 mm | 1.4 mm | 1.5 mm |
| portion | | | | | |
| thickness | | | | | |
| Core back | 15 | 18 | 25 | 14 | 17 |
| portion weight | | | | | |
| reduction | | | | | |
| ratio % | | | | | |
| Non-core back | 8 | 8.3 | 10.5 | 8.5 | 8.6 |
| portion weight | | | | | |
| reduction | | | | | |
| ratio % | | | | | |
| Shape precision | very good | very good | very good | very good | very good |

Molding was performed under the conditions in Table 1 using a foaming resin material wherein, for three types of resin which are PC+ABS, PBT-GF 30%, and PPE+PS, resin is melted within a mold cylinder, nitrogen gas is injected into the melted resin material under high pressure, and nitrogen is melted as a foaming agent. Note that the employed molding machine was a JSW350 Ton molding machine.

With Embodiments 30 through 34, the formed portions formed by the movable core and outer slide have a weight reduction ratio that is greater as compared to other portions.

### Embodiment 35 Through Embodiment 39

Molding was performed using a mold according to the present invention (mold described in FIG. 14) under molding conditions described in Table 9. Also, molding results are also described in Table 9.

TABLE 9

| | Embodiment | Embodiment | Embodiment | Embodiment | Embodiment |
|---|---|---|---|---|---|
| | 35 | 36 | 37 | 38 | 39 |
| Resin material | PC + ABS | PPE − PS | PBT − GF30 | ABS | HIPS |
| Foaming | nitrogen | nitrogen | nitrogen | nitrogen | nitrogen |
| agent | | | | | |
| Resin | 250° C. | 300° C. | 270° C. | 210° C. | 200° C. |
| temperature | | | | | |
| Mold | 50° C. | 40° C. | 80° C. | 35° C. | 40° C. |
| temperature | | | | | |
| Filling time | 1.0 sec | 1.5 sec | 0.8 sec | 1.2 sec | 1.2 sec |
| Pressure | 0.8 sec | 0.8 sec | 0.5 sec | 0.8 sec | 0.8 sec |
| keeping time | | | | | |
| Pressure | 70 MPa | 70 MPa | 50 MPa | 60 MPa | 60 MPa |
| keeping force | | | | | |
| Cooling time | 12 sec | 12 sec | 10 sec | 12 sec | 12 sec |
| Core back | 0.5 sec | 0.5 sec | 0.5 sec | 0.5 sec | 0.5 sec |
| time | | | | | |
| Core back | 0.9 sec from | 0.9 sec from | 0.6 sec from | 0.9 sec from | 0.9 sec from |
| start timing | V-P switching | V-P switching | V-P switching | V-P switching | V-P switching |
| Core back | 1.0 mm | 1.0 mm | 1.0 mm | 1.0 mm | 1.0 mm |
| movement | | | | | |
| amount | | | | | |
| Initial top face | 2.0 mm | 2.0 mm | 2.0 mm | 2.0 mm | 2.0 mm |
| portion | | | | | |
| thickness | | | | | |
| Indentation | 0.8~0.12 | 0.1~0.13 | 0.06~0.1 | 0.05~0.1 | 0.05~0.1 |
| line width mm | | | | | |
| Indentation | 0.01 | 0.01 | 0.01 | 0.01 | 0.01 |
| line depth mm | | | | | |

For the five different types of resin materials in Embodiments 35 through 39, the molding conditions under which molding is performed with the mold and molding method according to the present invention, and the width and depth of minute indentation lines that occur in the boundary between the movable-core and outer slide and fixed-side mold plate illustrates in FIG. 15B 921 and 922, are indicated.

The width of the groove for any of the materials is 0.13 mm or less, and the depth of the groove is also approximately 0.01 mm, whereby the levels thereof are such that influence to be given on the strength of a molding part is not a problem. Also, even in a case of applying the present invention to an external part which calls for an external view, the minute indentation lines are of a level that do not pose a problem as to external view quality.

This occurrence of a minute step can be conceived because the cooling speed of the boundary faces of the movable core and outer slide and fixed side mold plate was fast, the resin viscosity was increased due to cooling, and accordingly, at the time of the movable core and the outer slide moving, the resin did not move following the surface of a moving mold.

Also, with the present invention, as indicated in Embodiments 33 and 37, it was found that a foaming component with high shape precision is obtained by performing the foam-mold and manufacturing method according to the present invention on even a material including glass filler of which the viscosity increase speed at the time of cooling is fast.

### Embodiment 40 Through Embodiment 44

Molding was performed using a mold according to the present invention (mold described in FIG. 14) under molding conditions described in Table 10. Also, molding results are also described in Table 10.

TABLE 10

| | Embodiment | Embodiment | Embodiment | Embodiment | Embodiment |
|---|---|---|---|---|---|
| | 40 | 41 | 42 | 43 | 44 |
| Resin material | PC + ABS | PPE − PS | PBT − GF30 | PBT − GF30% | PBT − GF30% |
| Foaming agent | nitrogen | nitrogen | nitrogen | nitrogen | nitrogen |
| Resin temperature | 250° C. | 250° C. | 250° C. | 270° C. | 270° C. |
| Mold temperature | 50° C. | 50° C. | 50° C. | 80° C. | 80° C. |
| Filling time | 1.0 sec | 1.0 sec | 1.0 sec | 0.8 sec | 0.8 sec |
| Pressure keeping | 0.5 sec | 0.5 sec | 0.5 sec | 0.5 sec | 0.5 sec |
| time | | | | | |
| Pressure keeping | 60 MPa | 60 MPa | 60 MPa | 70 MPa | 70 MPa |
| force | | | | | |
| Cooling time | 12 sec | 12 sec | 12 sec | 8 sec | 8 sec |
| Core back time | 0.5 sec | 0.5 sec | 0.5 sec | 0.5 sec | 0.5 sec |
| Core back start | 0.6 sec from | 0.6 sec from | 0.6 sec from | 0.6 sec from | 0.6 sec from |
| timing | V-P switching | V-P switching | V-P switching | V-P switching | V-P switching |
| Core back | 1.0 mm | 1.0 mm | 1.0 mm | 1.0 mm | 1.0 mm |
| movement amount | | | | | |
| Initial top face | 1.5 mm | 1.5 mm | 1.5 mm | 1.5 mm | 1.5 mm |
| portion thickness | | | | | |
| Clearance before | 0.15 | 0.1 | 0 | 0.1 | 0.08 |
| mold clamping of | | | | | |
| fixed-side mold | | | | | |
| plate and outer | | | | | |
| slide | | | | | |
| Clearance after | 0.05 | 0 | −0.1 | 0 | −0.02 |
| mold clamping of | | | | | |
| fixed-side mold | | | | | |
| plate and outer | | | | | |
| slide | | | | | |
| Burring | Burring | No | No | Burring | No |
| | occurred | occurrence | occurrence | occurred | occurrence |
| Slide movement | very good | very good | fair | very good | very good |
| operation | | | | | |

The mold clamping force was 350 t, and mold compression deformation amount due to the mold clamping force was 0.1 mm.

In Table 10, with Embodiments 41 and 42 wherein a clearance between the slide and fixed-side mold plate indicted with 891 in FIG. 14 was set to between 0 mm and −0.1 mm after mold clamping, the levels were without occurrence of burring or problems of outer slide movement operations.

Also, with the PBT material indicated in Embodiments 43 and 44, in the event that clearance was set to −0.02, burring did not occur, and movement of the outer slide was also favorable.

Note that, with other than the materials indicated in the Embodiments of the present invention in Tables 8 through 10, the present invention is effective as to existing techniques, and accordingly, the present invention is not restricted to the range indicated with the Embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-190374, filed Sep. 1, 2011, which is hereby incorporated by reference herein in its entirety.

1. A foam-molding parts manufacturing method, wherein a said fixed-side mold plate and a movable-side mold plate are closed, thereby forming a cavity within a mold, and a foaming resin is injected into said cavity, and then, the capacity of said cavity is expanded to promote foaming within said cavity, and after cooling, said fixed-side mold plate and said movable-side mold plate are opened to extract a molding part from said cavity;
wherein expansion of the capacity of said cavity is performed by moving a movable core forming a portion of said cavity relative to said cavity while closing said fixed-side mold plate and said movable-side mold plate.

2. The foam-molding parts manufacturing method according to claim 1, wherein a second movable-side mold plate that can be separated from said moveable-side mold plate is included, said movable core is fixed to said second movable-side mold, and the movement of said movable core is performed by separating said second movable-side mold plate from said movable-side mold plate and moving toward the mold-opening direction.

3. The foam-molding parts manufacturing method according to claim 1, wherein a second fixed-side mold plate that can be separated from said fixed-side mold plate is included, said movable core is fixed to said second fixed-side mold plate, and the movement of said movable core is performed by separating said fixed-side mold plate from said second fixed-side mold plate and moving toward the mold-opening direction.

4. The foam-molding parts manufacturing method according to claim 1, wherein said mold further includes an insert block making up a portion of said cavity, and said insert block is pressed against said fixed-side mold plate at the time of movement of said movable core.

5. The foam-molding parts manufacturing method according to claim 1, wherein said mold further includes an insert block making up a portion of said cavity, and said insert block is moved in the direction of said cavity expanding, while said fixed-side mold plate and said movable-side mold plate remain closed.

6. The foam-molding parts manufacturing method according to claim 4, wherein a circular shape is formed on said movable core and said insert block, and after movement of said movable core, a curvature is formed with the circular shape formed on said movable core, and the circular shape formed on said insert block.

7. The foam-molding parts manufacturing method according to claim 1, wherein said mold further includes a tip portion of an ejector pin making up a portion of said cavity, the tip portion of said ejector pin is disposed in the same face as the surface of a movable core forming said cavity after moving said movable core at the time of injecting said resin, and after moving said movable core, forms the same face as the surface of said movable core.

8. A foam-molding part which is a box-shaped foam-molding part made up of a top face portion and a side face portion, wherein a weight reduction ratio of said side face portion is smaller as to a weight reduction ratio of said top face portion.

9. The foam-molding part according to claim 8, wherein the weight reduction ratio of said side face portion is equal to or smaller than 50% as to the weight reduction ratio of said top face portion.

10. The foam-molding part according to claim 8, wherein an undercut-shaped portion is provided to said side face portion, and a weight reduction ratio of said undercut-shaped portion is smaller as to the weight reduction ratio of said top face portion.

11. The foam-molding part according to claim 10, wherein the weight reduction ratio of said undercut-shaped portion is equal to or smaller than 40% as to the weight reduction ratio of said top face portion.

12. The foam-molding part according to claim 8, wherein, with said side face portion, edge faces have a semicircular shape, and cell density in said semicircular shape portion is higher in the inner face side.

13. A foam-mold which is a foam-mold configured to inject a foaming resin into a cavity to form a foam-molding part, including a main parting made up of a fixed-side mold plate and a movable-side mold plate, a sub parting made up of a movable-side mold plate and a second movable-side mold plate or a sub parting made up of said fixed-side mold plate and the second fixed-side mold plate, and a movable core forming a portion of said cavity, wherein said movable core moves relative to said cavity in the direction of expanding said cavity while opening said sub parting.

14. The foam-mold according to claim 13, wherein a driving unit configured to press said movable-side mold plate against said fixed-side mold plate is provided to said second movable-side mold plate so as not to open said main parting.

15. The foam-mold according to claim 13, wherein a driving unit configured to press said fixed-side mold plate against said movable-side mold plate is provided to said second fixed-side mold plate so as not to open said main parting.

16. The foam-mold according to claim 13, further comprising: an insert block making up said cavity.

17. The foam-mold according to claim 16, wherein a mold combining portion between said insert block and said movable core has a slant of equal to or greater than 0.5 degrees and equal to or smaller than 5 degrees as to the mold opening direction.

18. The foam-mold according to claim 16, wherein a gap of equal to or greater than 0.01 mm and equal to or smaller than 0.05 mm is provided to a mold combining portion between said insert block and said movable core.
